(19) United States
(12) Patent Application Publication
(10) Pub. No.: US 2022/0168921 A1
(43) Pub. Date: Jun. 2, 2022

(54) FORMWORK FOR PRODUCING CONCRETE TUBBING IN A TUNNEL LINING SYSTEM

(71) Applicant: HERRENKNECHT AG, Schwanau (DE)

(72) Inventor: Stefan MEDEL, Gengenbach (DE)

(21) Appl. No.: 17/599,732

(22) PCT Filed: Apr. 7, 2021
(86) PCT No.: PCT/EP2020/059870

§ 371 Date: Sep. 29, 2021

(30) Foreign Application Priority Data
Apr. 7, 2019 (DE) 10 2019 109 084.9

(51) Int. Cl. B28B 5/04

(52) U.S. Cl. CPC B28B 5/04; E21D 11/086

(57) ABSTRACT

The invention relates to formwork for producing concrete tubbing (500) for a tunnel lining system, with a concrete tub to receive a volume of concrete required to produce the tubbing and, if necessary, to receive the intended reinforcement for the concrete tubbing (500), wherein the concrete tub has at least one base and walls (14, 15) on the base adapted to the mould, wherein at least one wall is arranged detachably from the base and can be pivoted relative to the base between a closed position and an opened position. According to the invention, the formwork has at least one drive system for pivoting the at least one wall between the open and the closed position and for holding same in the relevant position, and the drive system has at least one actuator for pivoting the at least one wall between the open and the closed position.

The invention relates to formwork for producing concrete tubbing for a tunnel lining system, having a concrete tray for receiving a quantity of concrete required for producing the tubbing and, if required, for receiving the envisaged reinforcement of the concrete tubbing, wherein the concrete tray has at least one base and on the base walls adapted to the shape, wherein at least one wall is disposed so as to be releasable from the base and pivotable between a closed position and an opened position in relation to the base.

In order for concrete tubbing to be produced, the individual operating steps for producing a concrete tubbing are carried out manually. Besides the operating costs arising here, the work to be carried out is monotonous and stressful to the operators. Furthermore, the activities are carried out using heavy objects such that there is a risk of injury. Despite the repetitive activities, it is at the same time necessary for the works to be carried out with very high precision.

This relates in particular to the use of the formwork units. The latter have to be partially or completely opened or closed at different workstations of the production line. This takes place manually here and is therefore intensive in terms of labor and time. Furthermore, a significant degree of care has to be taken when closing in order for the formwork units to be tight and the concrete introduced while concreting not to leak.

It is therefore an object of the invention to alleviate at least some aspects of the aforementioned issues.

The object is achieved in that the formwork has at least one drive system for pivoting the at least one wall between the open and the closed position and for retaining said wall in the respective position, and that the drive system has at least one actuator for pivoting the at least one wall between the open and the closed position.

As a result thereof it is possible for the opening and closing to be simplified in a simple manner and to ensure at the same time that the position is retained in a simple manner, so that the formwork remains securely closed.

A further teaching of the invention provides that at least two walls at one of the two external end regions of said walls contact one another by way of the short sides of said walls in the closed position, hereby configuring a corner of the concrete tray. It is advantageous here for a male engagement element to be provided in the external end region on one of the two walls, and for a female engagement element to be provided in the external end region on the other wall, said engagement elements in the closed position of the two walls engaging in one another. As a result thereof, the closure of the corner can be ensured in a simple manner.

It is furthermore advantageous here for the two walls in the external end regions thereof to be connected to one another by means of at least one screw connection or a clamping connection, wherein the screw connection or the clamping connection preferably serves for securing the position, and/or wherein the screw connection has a screw having a spring element which is disposed along at least part of the screw. Said spring element represents in particular a simple additional securing feature by way of which the positioning is guaranteed in a simple manner.

A further teaching of the invention provides that the clamping connection has a locking element which is disposed on one of the wall elements and, by at least one actuator, for example a hydraulic cylinder or a spindle system, is pivotably movable between an open position and a closed position. It is advantageous here for the actuator to be connected to the drive system described hereunder. As a result thereof, a securing feature can be provided in a simple manner.

A further teaching of the invention provides that the at least one wall for moving between the open position and the closed position is connected to at least two actuators of the drive system. As a result thereof, the required retaining forces can be applied and distributed in a simple manner.

A further teaching of the invention provides that the at least one wall element has two external end regions and that at least one actuator for moving and retaining the wall element is provided per end region. It has been demonstrated that a tight closure can be guaranteed in a particularly simple manner as a result thereof, even during filling of the formwork with concrete and any potential deformation of the lateral walls.

A further teaching of the invention provides that the drive system at a workstation for driving the drive system is able to be connected to an external drive. The construction of the formwork can consequently be as simple as possible as a result thereof because a drive in the formwork can be dispensed with.

A further teaching of the invention provides that the drive system is a hydraulic system having at least one hydraulic circuit, wherein the drive system as an actuator has at least one hydraulic cylinder which is connected to the hydraulic circuit. The moving action as well as the retaining action can be provided in a simple manner by way of adequate forces as a result thereof.

It is advantageous here for the hydraulic circuit to have a blocking element for maintaining the pressure in the hydraulic circuit, said blocking element preferably being a load-bearing valve. It is furthermore advantageous here for the hydraulic circuit to have an element for equalizing a variation in terms of pressure and/or a variation in terms of volume in the hydraulic circuit, this preferably being a dummy cylinder or a diaphragm accumulator. It is furthermore advantageous here for the hydraulic circuit to have at least one connector element for releasably connecting the hydraulic circuit to a hydraulic apparatus as the external drive of the drive system at a workstation. It is furthermore advantageously provided that the individual hydraulic cylinders are connected by means of pressure sequence valves. Sequential controlling of the individual steps of opening and/or closing the formwork can be achieved in a simple manner as a result thereof. A hydraulic circuit according to the invention can be provided in a simple manner by at least one of the previously mentioned elements.

A further teaching of the invention provides that the drive system as an actuator is a mechanical drive, preferably a spindle drive. It is advantageous here for the mechanical drive to be conceived so as to be self-locking, or to be provided with a blocking element. It is furthermore advantageous here for the mechanical drive to have a connection element for releasably connecting to an external rotational drive, for example a torque driver, as the external drive of the drive system at a workstation.

A further teaching of the invention provides that at least one cover element is provided so as to be pivotable on the formwork, said cover element being able to be disposed on the upper side of the concrete tray and on the latter at least partially covering the upper side. It is advantageous here for the cover element by at least one actuator, for example a hydraulic cylinder or a spindle system, to be pivotable between an open position and a closed position, said actuator preferably retaining the cover element in the respective position. It is furthermore advantageous here for the actuator to be connected with the previously described drive system.

A further teaching of the invention provides that the cover element has an arrestor element which arrests the cover element in the closed position in relation to the formwork.

The invention will be explained in more detail hereunder by means of exemplary embodiments in conjunction with a drawing, in which:

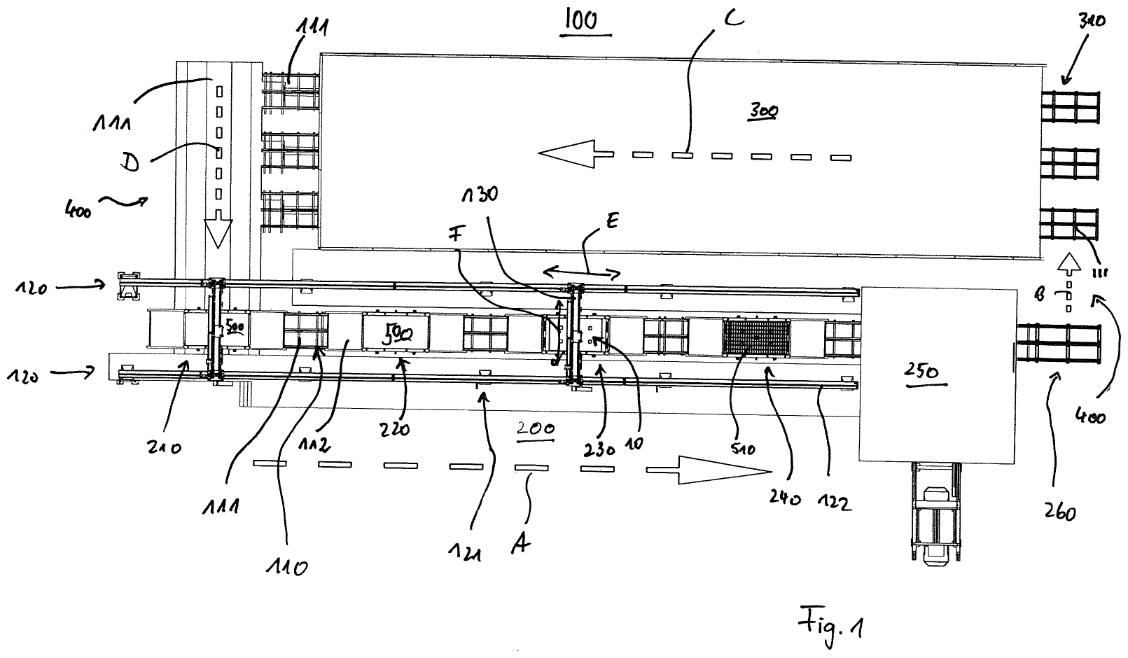

FIG. 1 shows a plan view of a production plant according to the invention;

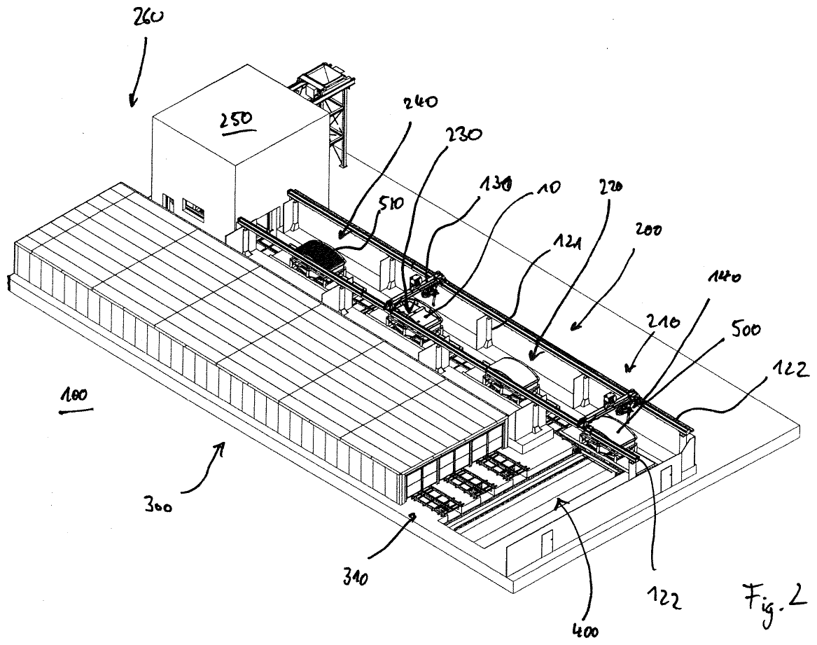

FIG. 2 shows an isometric view of FIG. 1;

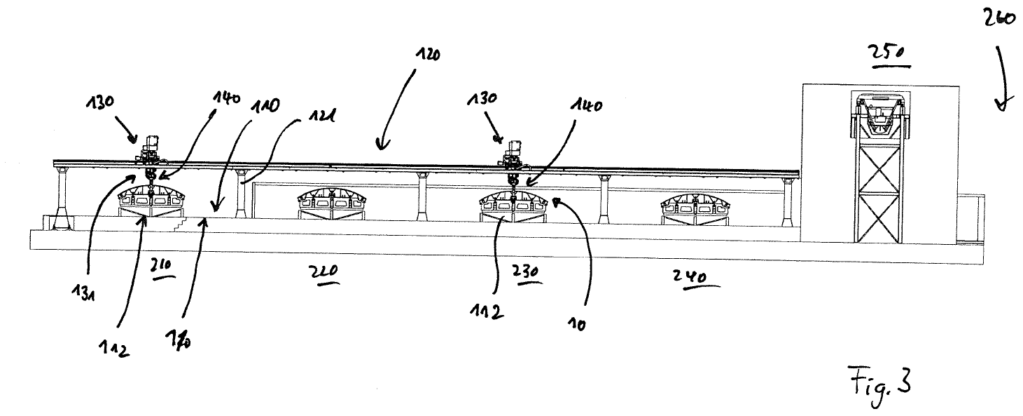

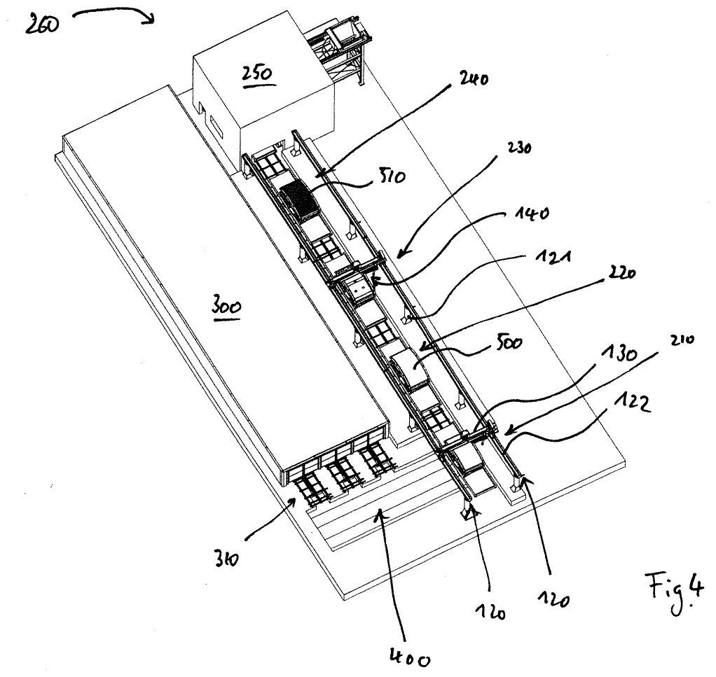

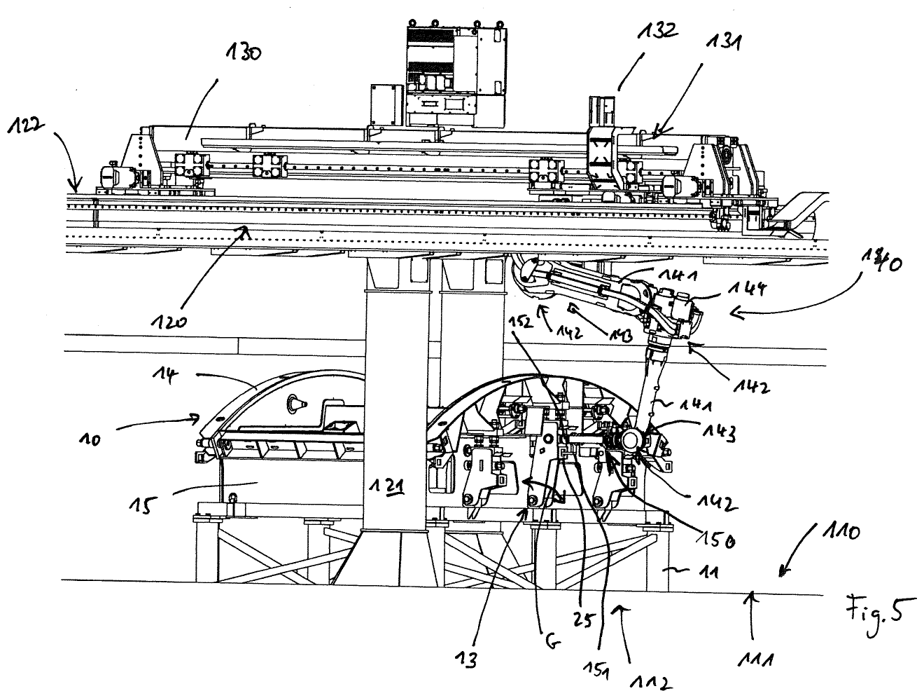

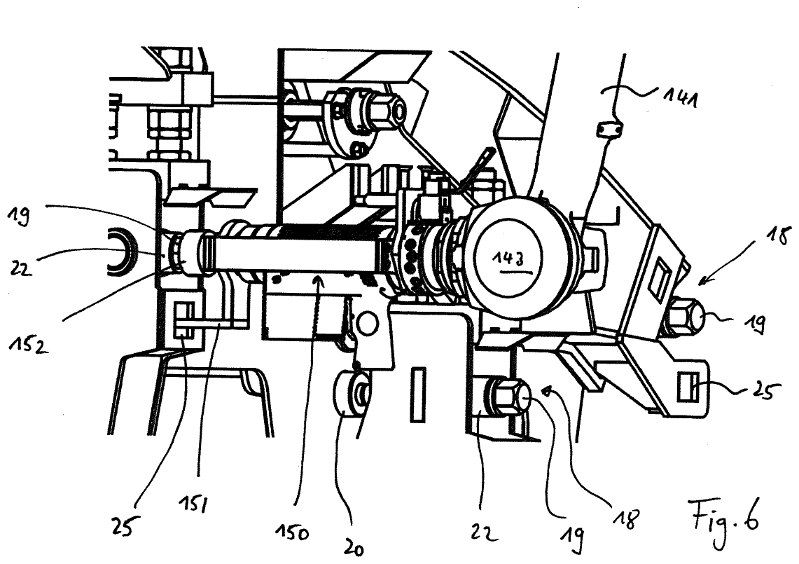

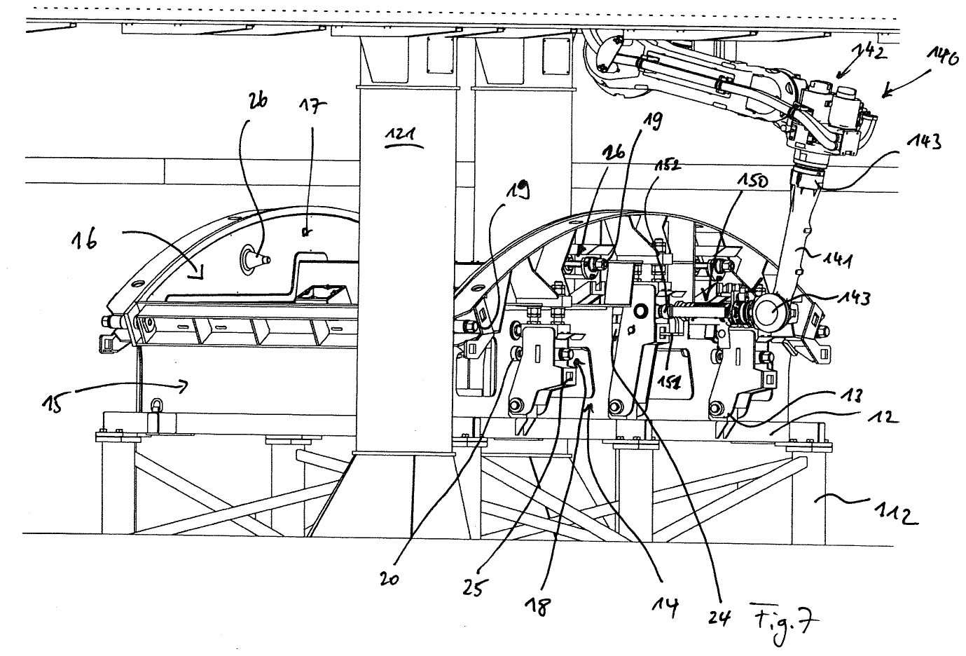

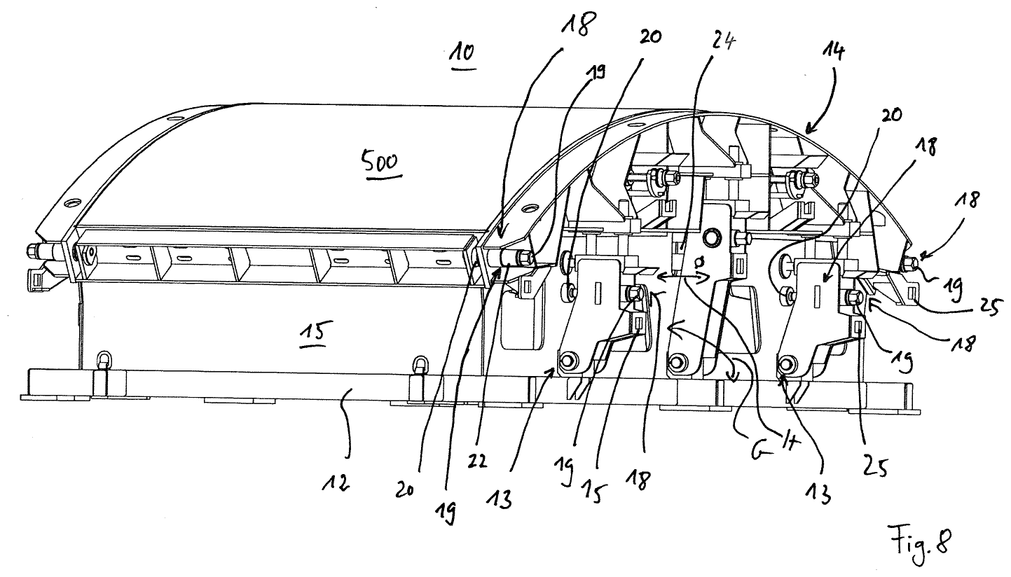

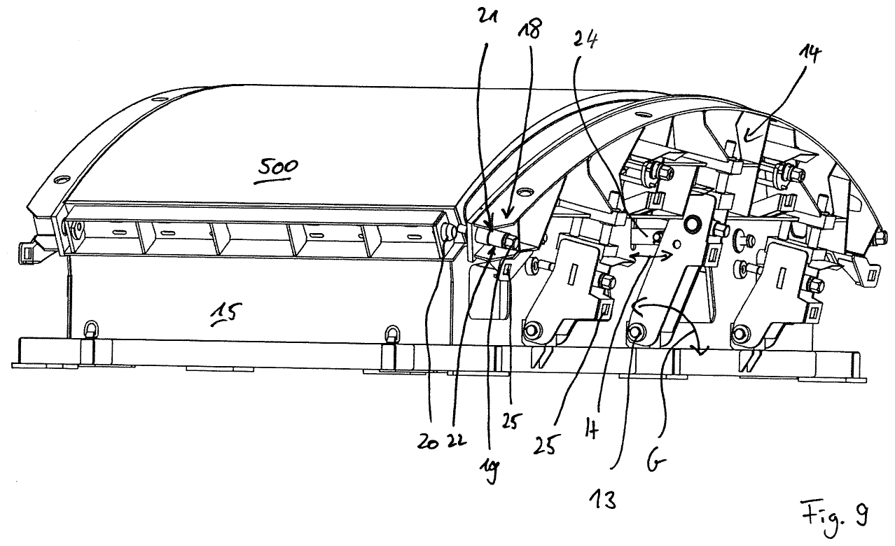

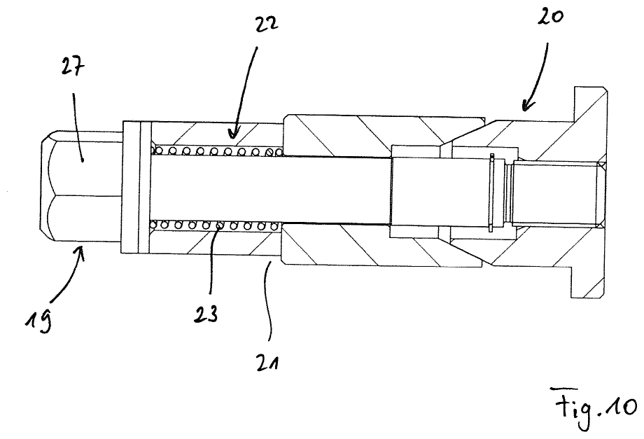

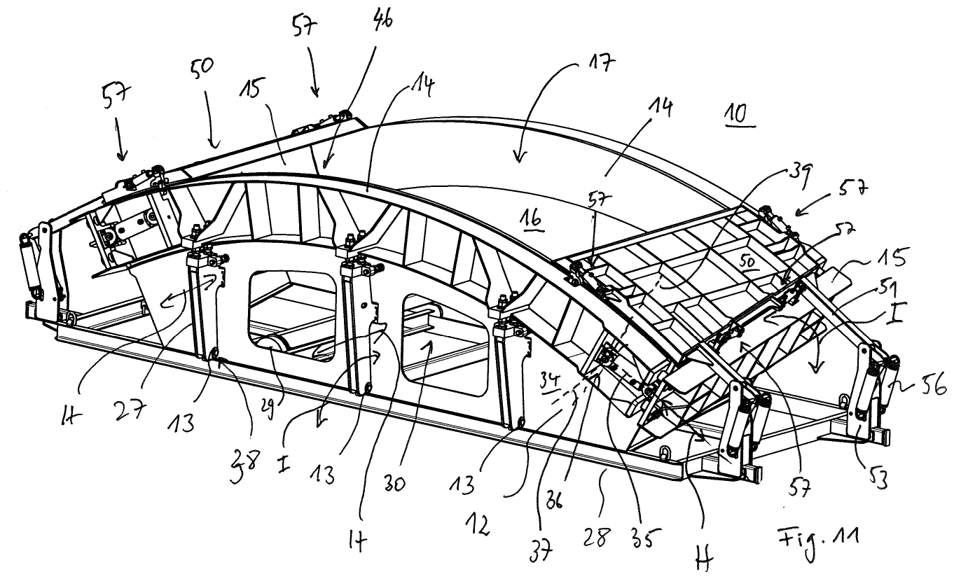

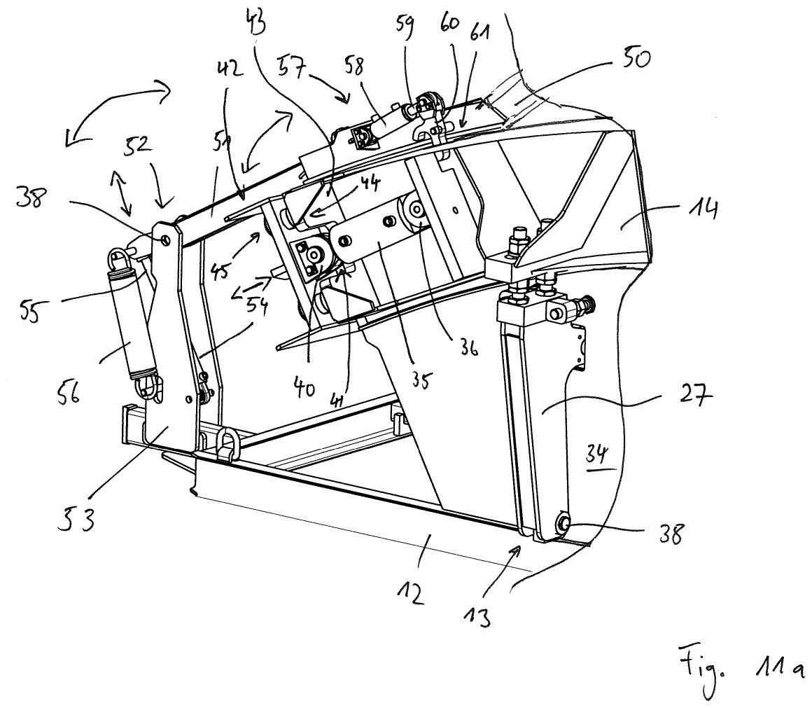

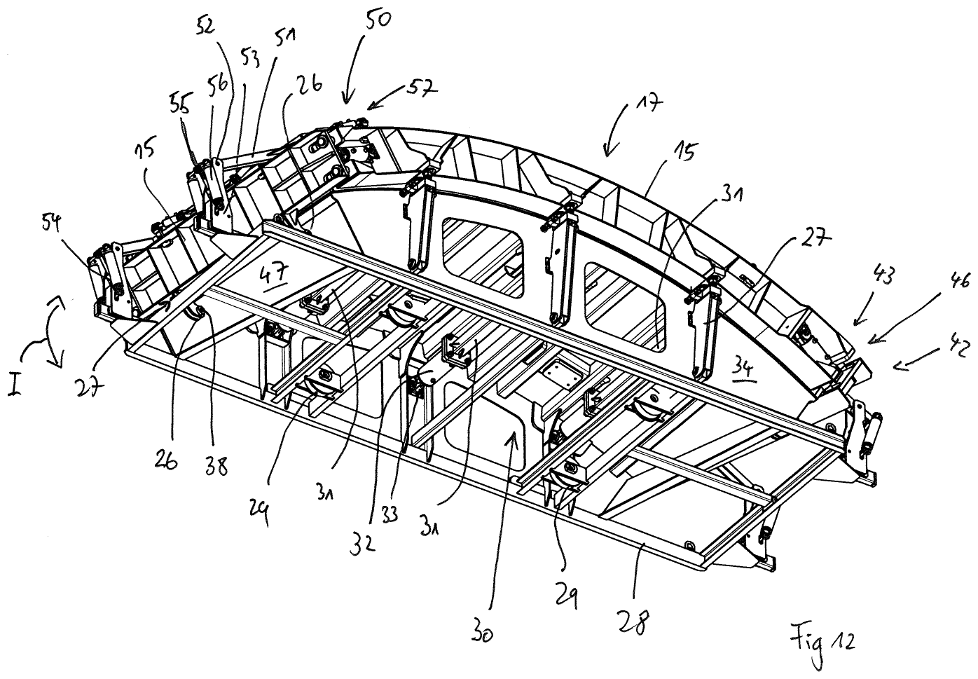

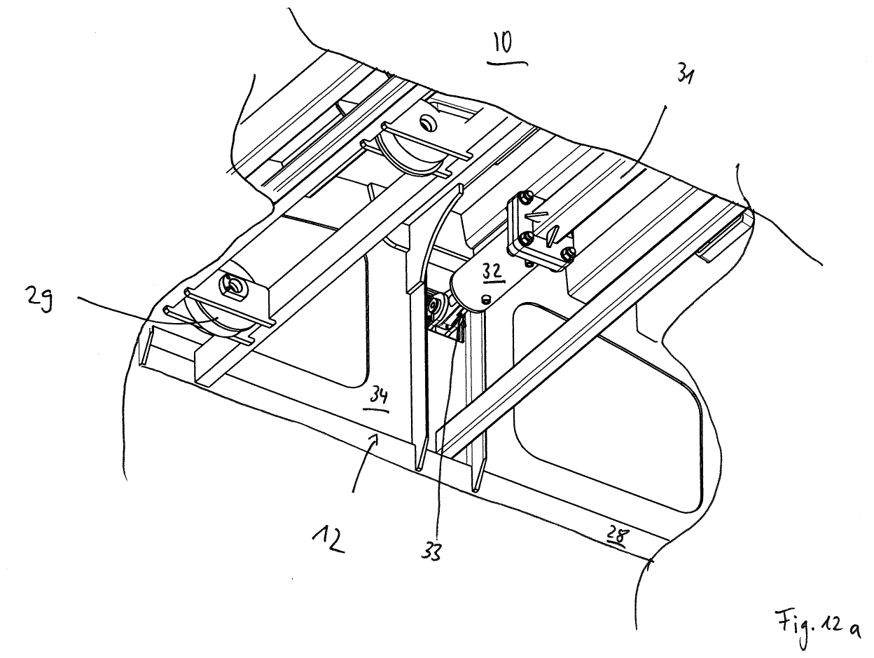

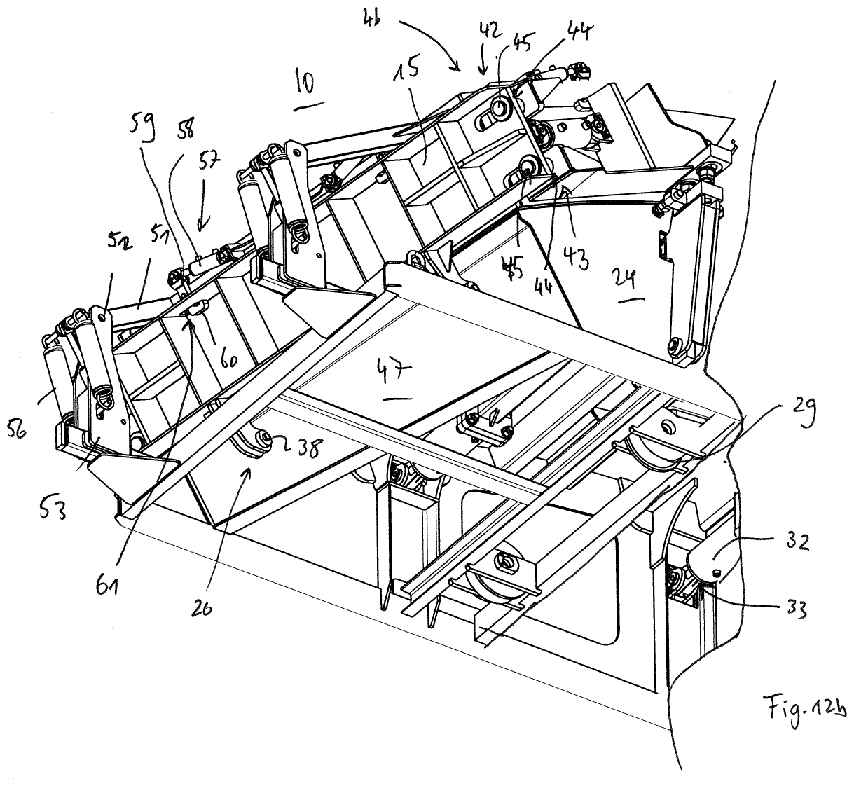

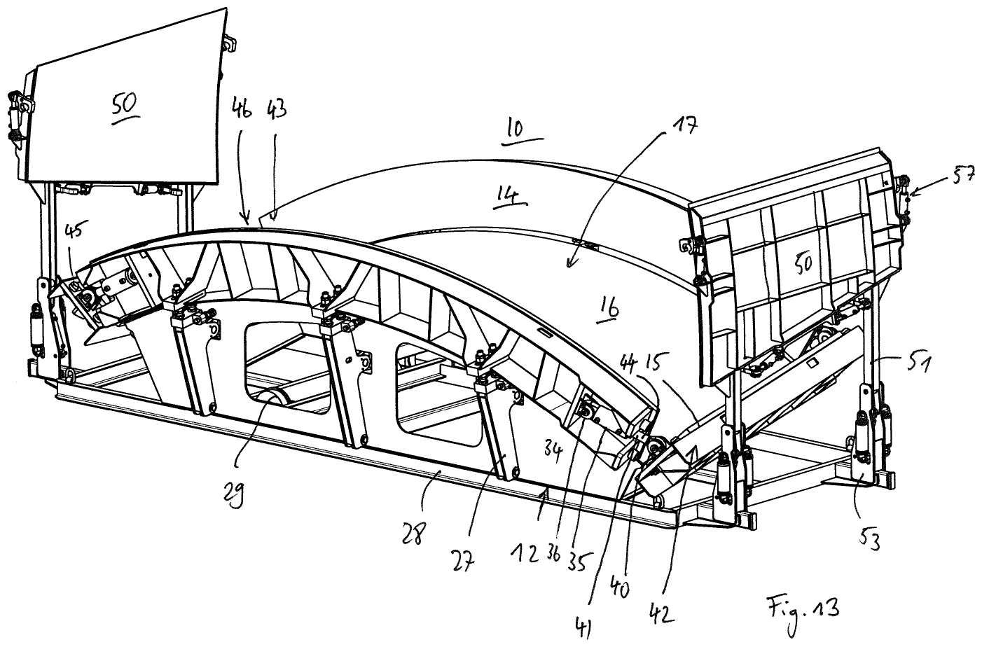

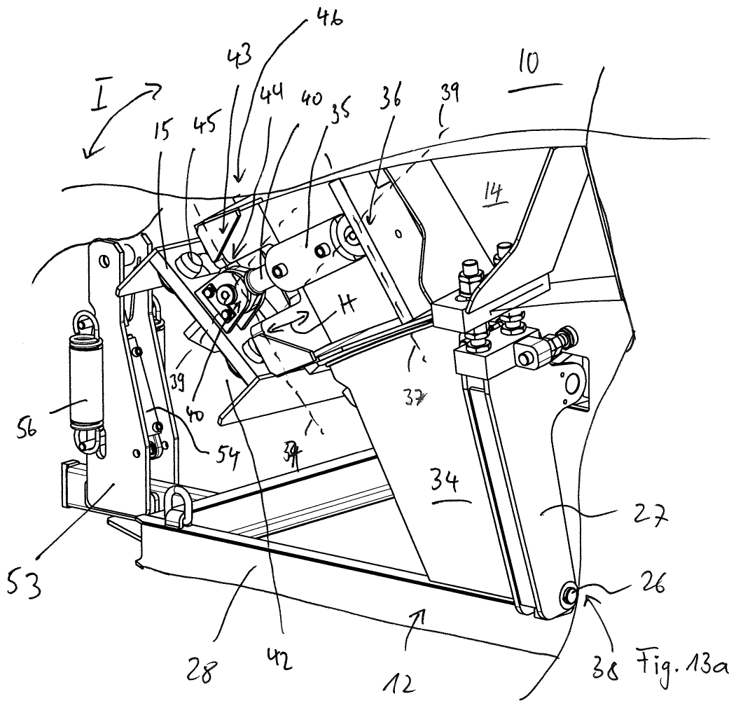

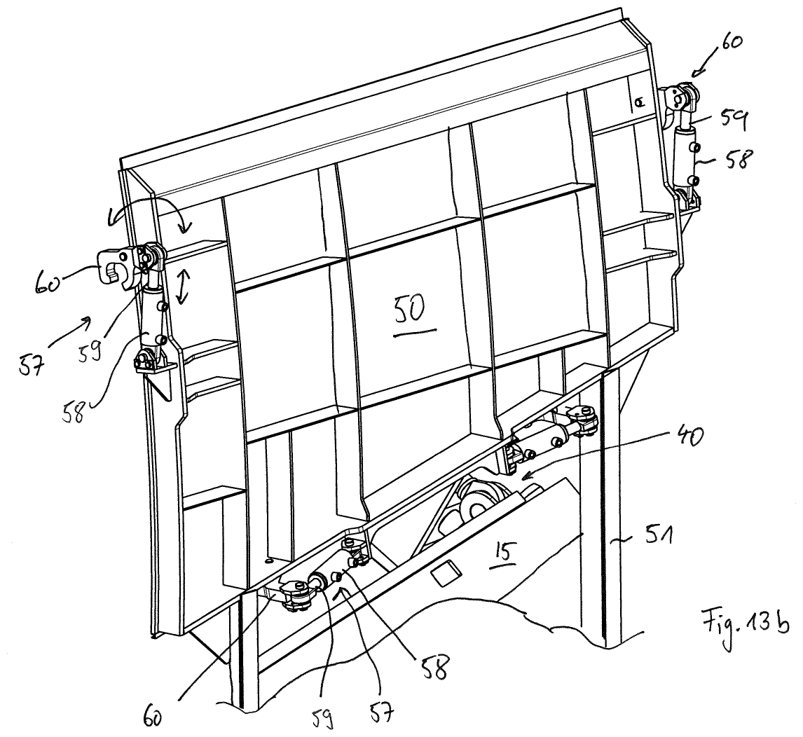

FIG. 3 shows a lateral view of FIG. 1;

FIG. 4 shows a further isometric view of FIG. 1;

FIG. 5 shows an isometric enlargement of a fragment of FIG. 3;

FIG. 6 shows an isometric enlargement of a fragment of FIG. 5;

FIG. 7 shows an isometric view of a first embodiment of formwork according to the invention;

FIG. 8 shows an enlarged view of a fragment of FIG. 7;

FIG. 9 shows an isometric view of an opened first embodiment of the formwork according to the invention;

FIG. 10 shows a sectional view through a fastening element of FIG. 7;

FIG. 11 shows an isometric view of a second embodiment of formwork according to the invention in a closed state;

FIG. 11a shows an enlarged view of a fragment of FIG. 11;

FIG. 12 shows a lower view of FIG. 11;

FIG. 12a shows an enlarged view of a fragment of FIG. 12;

FIG. 12b shows a further enlarged view of a fragment of FIG. 12;

FIG. 13 shows an isometric view of a second embodiment of formwork according to the invention in an opened state;

FIG. 13a shows an enlarged view of a fragment of FIG. 13;

FIG. 13b shows a further enlarged view of a fragment of FIG. 13;

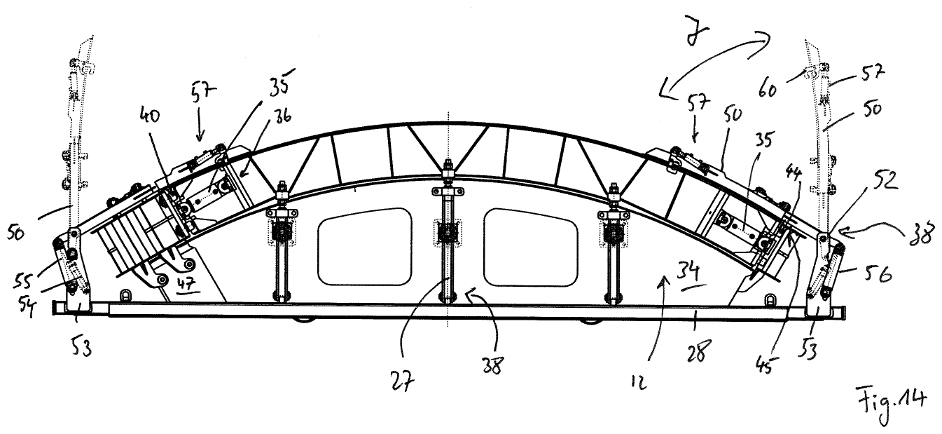

FIG. 14 shows an isometric lateral view of the lateral wall of the formwork according to the invention of FIGS. 11 and 13; and

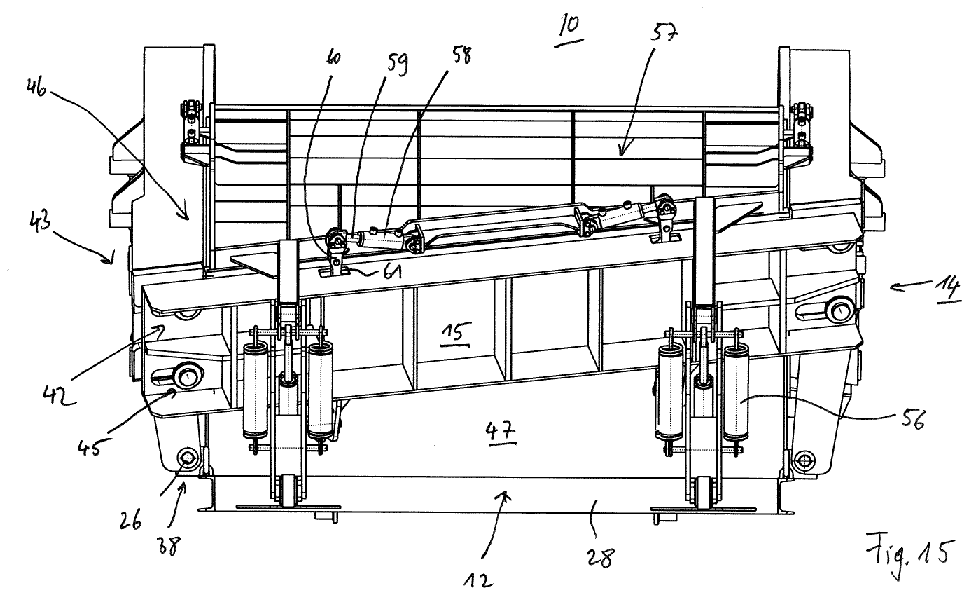

FIG. 15 shows an isometric lateral view of the end wall of the formwork according to the invention.

FIGS. 1 to 4 show a production plant 100 for concrete tubbings 500 in which a formwork 10 according to the invention is used. The production plant 100 here is embodied as a carousel plant for the formworks 10, for example. Alternatively, the formwork according to the invention can also be used in a stationary plant (not illustrated), in which the formwork for the production steps prior to the introduction to a curing plant for the accelerated primary curing of the concrete tubbing 500, should this curing be required. remain at one location.

The carousel plant shown by way of example here is composed of at least one production line 200 and a curing tunnel 300. The curing tunnel 300 here has at least one curing line 310, for example, whereby three curing lines 310 are illustrated in FIG. 1. The production line 200 and the curing tunnel 300, or the curing lines 310 thereof, respectively, are connected by a transverse conveyor 400.

The production plant 100 has, for example, a transport route 110. The transport route 110 has, for example, a track 111 on which the formwork 10 is displaceable. To this end, the formwork has either its own transport means, for example in the form of wheels, or the formwork 10 is disposed on a separate transport means 112. The formwork 10/the transport means 112 moves/move in the direction of the arrow A along the transport route 110 through the production line 200, for example via driving of the wheels or via an actuator (not shown).

Having passed through the production line 200, the formworks 10 by a transverse conveyor 400 are supplied in the direction of the arrow B to the curing lines 310 of the curing tunnel 300. The transverse conveyor 400 also has a track 111 on which the formwork 10/the transport means 112 are moved, for example via driving of the wheels or via an actuator (not shown). The same also applies to the curing lines 310 of the curing tunnel 300.

Having passed through the curing tunnel 300 in the direction of the arrow C, the transport means 112 by means of the transverse conveyor 400 are again supplied in the direction of the arrow D to the production line 200. The carousel is then completed.

The production line 200, when viewed in the direction of the arrow A, from the left to the right in FIG. 1, in an exemplary manner here has six workstations 210-260.

At the first workstation 210, the formwork 10 is opened as explained hereunder.

At the second workstation 220, the finished tubbing 500 is retrieved from the formwork 10 by means of a lifting element (not illustrated). This can alternatively also already take place at the first workstation 210 and the workstation 220 can then be dispensed with.

At the third workstation 230, the preferably opened formwork 10 is cleaned and prepared for receiving installation elements as well as for concreting. To this end, a release agent (formwork oil), for example, is applied to all faces and parts of the formwork which come into contact with the concrete of the tubbing 500 to be produced and are not intended to be a component part of the tubbing 500.

At the fourth workstation 240, the formwork 10 is equipped with the installation components which are a component part of the finished tubbing 500. This here is, for example, a reinforcement 510, erector anchors (not illustrated), a protective liner, or the like.

After the installation parts have been introduced, the latter alternatively also being able to be completely or partially introduced into the formwork 10 at the third workstation 230, after the cleaning and the preparation has been completed, the formwork 10 having the introduced components is checked so as to guarantee that the formwork 10 is correctly assembled and the installation parts of the tubbing 500 are correctly disposed.

The equipping of the formwork 10 with the installation parts can also take place so as to be divided between the workstations 230, 240.

In the fifth workstation 250, unless already performed prior hereto, the optionally provided covers (not illustrated) of the formwork are assembled. Alternatively, the covers can, if they are disposed moveably on the formwork 10, be closed prior to entry into the fifth workstation 250 or in the fifth workstation 250. This closure is explained hereunder. The concrete to be introduced into the formwork 10 is prepared according to the required mixture and at the required quantity and incorporated into the formwork 10 in the fifth workstation 250. The introduced concrete is subsequently compacted in a known manner, for example by vibration. Alternatively, the introduction and compaction take place in a plurality of steps.

Prior to or in the sixth workstation 260, the cover or covers of the formwork 10 is/are removed/opened and the concrete surface 520 of the tubbing is treated, for example smoothed. After the treatment/smoothing, the covers of the formwork 10 are closed again, as described hereunder.

In this example, the production line 200 will be exited after the sixth workstation 260 in that the formwork 10/the transport means 112, having the formwork 10 and the raw tubbing 500 completely produced in the formwork 10, is transferred to the transverse conveyor 400.

The number of workstations here is to be considered to be purely exemplary. A person skilled in the art is readily able to adapt the number of workstations by combining the latter or by delinking individual operating steps according to the requirements.

A first embodiment of the formwork 10 (see FIGS. 5 to 10) is disposed above a pedestal 11 of the transport means 112, for example. The formwork per se has a base 12 by way of which said formwork is able to be disposed on the pedestal 11. An interior space 17 as a concrete tray is provided above the base, said interior space 17 being formed by a floor 16 and internal walls of the end walls 15 and lateral walls 14. The installation parts and the concrete are introduced into this concrete tray, or into this interior space 17, respectively.

The base 12 in this embodiment, although not limited thereto, is pivotably connected to two lateral walls 14 of the formwork 10 by way of pivoting connections 13. The formwork 10 furthermore has two end walls 15. In the formworks 10 shown in FIGS. 5 to 10, the end walls 15 are fixedly connected to the base 12. It is likewise possible here for the end walls 15 to be fixedly connected in a pivotable manner to the base 12 by way of articulated connections.

In the embodiment shown in FIGS. 5 to 10, the lateral walls 14 are connected in a retaining manner to the base 12 and the end walls 15 by way of screw connections. Such a screw connection is shown in a sectional illustration in FIG. 10. Said screw connection has a screw 19 which is screwed into a threaded element 20 which is disposed on the base 12 or on the end wall 15, for example. The screw 19 is inserted into a sleeve 21 which on the lateral wall 14 is attached above a through opening (not illustrated), for example. The sleeve 21 here has a spring portion 22 in which a spring 23 is provided.

When the threaded element 20 and the sleeve 21 are disposed so as to be mutually aligned on top of one another, for example when the lateral wall 14 is disposed against the end wall 15 and the base 12, the screw 19 can be screwed into the threaded element 20 and thus arrest the lateral wall 14 in relation to the base 12 and/or the end wall 15.

Provided to this end is a drive system which enables the lateral walls 14 to move in relation to the base 12 and/or the end walls 15, alternatively also the floor 16. This here can be a spindle system as a mechanical drive, for example, that when said spindle system is driven, the lateral walls 14 are moved in the direction of the double arrow G about the pivoting connection 13 either away from the base 12 and the end walls 15 and the floor 16, or toward said base 12 and said end walls 15 and said floor 16. Alternatively, other drive system such as, for example, hydraulic cylinders can also be used to this end. A further exemplary embodiment having a hydraulic drive system will be explained in a second exemplary embodiment according to the invention, but can also be alternatively used in the first exemplary embodiment.

If a mechanical drive system is used, said mechanical drive system can be conceived such that said mechanical drive system is self-locking so that no screw connections are required in order to retain the lateral walls 14 in relation to the floor 16 and the lateral walls 15. Alternatively or additionally, a blocking element (not illustrated) can also be used in order to guarantee a retaining action by preventing a reverse movement of the spindle drive.

In one preferred embodiment, the central spindle can also be driven by a suitable tool, preferably the same tool by way of which the screws 19 are released and tightened. A rod element 24 which is movable in the direction of the double arrow H by the central spindle is shown in FIGS. 7, 8 and 9.

Screwing the screw 19 into the threaded element 20 takes place counter to the spring element 23, the spring element 23 forcing the screw 19 outward when the latter is unscrewed, respectively, such that said screw when being unscrewed moves more easily out of the threaded element 20.

As a result thereof, it is possible in a simple manner when using a torque driver as the tool 150 on the robot 140, for said torque driver to be able to unscrew the screw 19 from the threaded element 20 such that said screw 19 is reliably released without the torque driver having to exert an extraction force on the screw 19.

Furthermore, the formwork 10 in the region of the screws 19 has engagement openings 25 into which a torque absorption element 151 engages so as to relieve the tool 150 creates or so as to relieve the robot 140, which otherwise would have to correspondingly absorb the torque.

A second embodiment of the formwork 10 according to the invention is illustrated in FIGS. 11 to 15.

The formwork 10 has an interior space 17 for receiving the reinforcement, installation parts and concrete for producing the concrete tubbing 500. The latter is formed by a floor 16 as well as the internal sides of the lateral walls 14 and of the end walls 15. The floor 16 here is disposed on a base 12.

The lateral walls 14 and the end walls 15 are fixedly disposed on the base so as to be pivotable by way of a pivoting connection 13, 26. The pivoting connection 13, 26 is in each case connected to the lateral wall 14, or to the end wall 15, by way of one connection element 27. The lateral walls 14 and the end walls 15 are pivoted about a pivot point 28 by way of the connection elements 27 such that the lateral walls 14 and the end walls 15 are released from the floor 16 and are pivoted outward, as is shown in FIG. 13. The pivoting takes place in the direction of the double arrow I.

The base 12 has a lower frame 28 on which inter alia a running gear for example is disposed, the latter here in an exemplary manner having wheels 29. Alternatively, the frame 28 can also be disposed on a transport element 112 so as to be displaced along a production line, or the travel route of the production line per se has rollers on which the formworks 10 are displaceable.

Base elements 31 and actuators 32, the latter here preferably in the form of hydraulic cylinders which are fixedly connected to the base element 31, are provided in an interior space 30 of the base 12. A moving element 33 of the actuator 32, here a piston rod, for example, is connected to the connection element 27. By moving the moving element 33 of the actuator 32 in a linear manner, the connection element 27 is moved from a lateral wall 34 of the base 12 in the direction of the double arrow H. Said connection element 27 is simultaneously rotated about the pivot point 38 such that the lateral wall 14 is moved away from the interior space 17, or the floor 16, respectively, such that the formwork 10 is opened in relation to the lateral walls 14.

At least one actuator 35, here a hydraulic cylinder, for example, is provided for opening the end walls 15, the latter likewise being connected to the base 12 by way of a connection element 27 having a pivoting connection 26 which has a pivot point 38. Said actuator 35, in a manner similar to the previously described actuator 32, can be disposed in conjunction with the base element 31 in the interior space 30. Alternatively, the actuator 35 by way of a connection 36 is disposed on the lateral wall 14. The actuator 35 in the connection 36 is rotatable about a first axis 37 and simultaneously disposed so as to be rotatable about a second axis 39 such that the actuator 35, when the end wall 15 is opened, can be pivoted conjointly with the lateral wall 14 when the latter is opened.

The same applies to the connection 40 by way of which the actuator 35 is connected to the end wall 15. The actuator 35 has a moving element 41, here a piston rod, for example, which can be moved in the direction of the double arrow H out of the actuator 35 so as to pivot the end wall 15 in the direction of the double arrow I about the pivot point 38 in the pivoting connection 26.

A corner 46 of the interior space 17 is formed as a result of an external side 42 of an end wall 15 contacting an external side 43 of the lateral wall 14. Additionally, a male engagement element 44 and a female engagement element 45, which in the closed state of the formwork engage in one another, are provided on the external side 42 of the end wall 15 and in analogous matching manner on the external side 43 of the lateral wall 14. The male engagement element 45 here is preferably disposed on the end wall 15, and the female engagement element 44 is preferably disposed on the lateral wall 14, such that the male engagement element 45 prevents the lateral wall 14 moving in the closed state of the end wall 15. By tightening and retaining the moving element 41 of the actuator 35, the end wall 15 at the external end 42 thereof is pressed onto the lateral wall 14 at the external end 43 of the latter. The male engagement element 45 simultaneously engages in the female engagement element 44 and as a result thereof blocks in addition to the tightening and retaining of the moving element 33 of the actuator 32 such that the lateral wall 14 cannot be released from the floor 16 as long as the end wall 15 bears on the floor 16. By tightening and retaining the moving element 41 of the actuator 35 at the external end 42, preferably in conjunction with the engagement elements 44, 45, opening of the corners 46 is simultaneously effectively and easily avoided, said corners 46 being formed between the lateral walls 14 and the end walls 15.

By distributing the pivoting connections 13, 26 along the lateral walls 34, 47 of the base 12 it is prevented that the lateral walls 14 and the end walls 15 are released from the floor 16, for example as a result of being deformed by the load of the introduced concrete.

The formwork 10 furthermore has two covers 50 which are attached to the base 12 and during the production process of the concrete tubbing 500 are either closed, as is illustrated in FIG. 11, or opened, as is illustrated in FIGS. 13 and 14.

The covers 50 can be pivoted in the direction of the double arrow J between the closed position on the interior space 17 and the open position. Said covers 50 serve for closing the formwork 10, or the interior space 17 thereof, respectively, toward the top when the concrete is filled into the interior space 17. In the production of tubbings, formworks 10 having partial covers, like the covers 50 shown in the second embodiment of the formwork 10 according to the invention here, or else without covers 50 as is the case in an exemplary manner in the first embodiment according to the invention, are known. The regions not covered, prior to filling the formwork 10 with concrete, are closed by a cover, whereby open regions through which the concrete is then filled into the interior space 17 are still present. These additional covers are attached before or in the concreting workstation.

If covers 50 which can be moved between an opened position and a closed position, are provided on the formwork 10, as here in the second exemplary embodiment, said covers 50 are closed in or before the concreting workstation. After concreting, the covers are either removed or opened again in order for the surface 520 of the raw concrete tubbing to be processed in a further operating step/in a corresponding further workstation. After this operating step has been completed, the covers 50 are closed again. The formworks 10 having closed covers 50 are subsequently supplied to the curing station. The covers 50 then remain correspondingly closed within the curing station. Once the curing has been completed, the covers 50 are opened. The lateral walls 14 and the end walls 15 are subsequently also opened in the required sequence. The pre-cured concrete tubbing 500 can be retrieved thereafter.

After the concrete tubbing 500 has been retrieved, the formwork 10 is correspondingly cleaned and prepared for the production of a new concrete tubbing 500, as has been described above. Depending on the possibility of transportation, the lateral walls 14, the end walls 15 and the covers 50 are either closed or remain in the opened state. The covers 50, the end walls 15 and the lateral walls 14 may have to be opened again in the cleaning station in order for complete cleaning to be able to be performed. The lateral walls 14 and the end walls 15 are closed after cleaning. The interior space 17 is then equipped with a corresponding reinforcement and corresponding installation parts. Once this has been completed, the formwork 10 is subsequently prepared for concreting as has been described above.

The covers 50 are provided with connection elements 51 which are connected to the base 12 by way of a pivoting connection 52. The pivoting connection 52 here is disposed so as to be rotatable on a protruding element 53. Provided is an actuator 54 which is connected to the base 12 in parallel with the protruding element 53. The connection element 51 extends beyond the pivoting connection 52. The moving element 55 of the actuator 54 then engages on this part of the connection element 51. By moving the moving element 55 in and out, the cover 50 is pivoted in the direction of the double arrow J about the pivot point 38, the latter being situated in the pivoting connection 52. Spring elements 56 are provided as facilitation in order to guarantee better opening and closing, or a better pivoting movement in the direction of the arrow J, respectively.

The actuator 54 here is preferably a hydraulic cylinder. The moving element 55 here represents the piston rod of the hydraulic cylinder. The actuator 54, apart from opening and closing, also has the effect of retaining the cover 50 in the respective position.

Additionally provided for securing on the cover 50 are securing elements 57 which are provided with an actuator 58 which has a moving element 59. The moving element 59 is connected to a blocking element 60 which by moving the moving element 59 in and out is movable, here preferably pivotable, between a locking position and a free position. Engagement openings 61 in which the blocking element 60 engages for locking are provided for locking on the lateral walls 14 and the end walls 15, respectively. The locking takes place during the curing, for example.

In order to control the actuators of the formwork 10, when said actuators are embodied as hydraulic cylinders, said actuators are part of a hydraulic circuit. The actuators hereunder are described as hydraulic cylinders. The hydraulic cylinders 32 for opening and closing the lateral walls, and the hydraulic cylinders 35 for opening and closing the end walls, here are provided such that the walls close when the hydraulic cylinder moves inward. The hydraulic cylinders 54 of the cover 50, and the hydraulic cylinders 58 for activating the blocking element 60, here are disposed such that the cover 50 and the blocking element 60 close when the hydraulic cylinder moves inward.

The hydraulic circuit at those respective workstations where the hydraulic cylinders have to be activated is connected to a hydraulic apparatus, not illustrated, by way of a connector. The application of the retaining force of the hydraulic cylinders after the lateral walls 14 and the end walls 15 have been closed, and after the covers 50 and the blocking element 60 have been closed, has to be maintained once the hydraulic circuit of the formwork 10 has been decoupled from the drive apparatus.

Maintaining the required closure forces takes place by non-return valves (not illustrated) which are introduced into the hydraulic circuit. The non-return valves have the effect that the hydraulic liquid introduced into the hydraulic cylinder cannot return from the latter once the hydraulic apparatus no longer impinges the hydraulic circuit with hydraulic fluid, as a result of which the pressure on the piston face of the hydraulic cylinder remains constant.

In order for variations in terms of pressure/variations in terms of volume in the hydraulic circuit, for example by virtue of variations in temperature in the curing plant, to be counteracted, compensation elements are provided at corresponding locations in the hydraulic circuit. These here can be, for example, diaphragm accumulators or dummy cylinders.

The required control sequence here results from which cylinders have to be first impinged with hydraulic liquid. Switchable blocking elements can be provided between the individual cylinders for sequencing the control of the individual movements. These here are preferably pressure sequence valves.

1-20. (canceled)

21. A formwork for producing concrete tubbing for a tunnel lining system, including a concrete tray for receiving a quantity of concrete required for producing the tubbing and, optionally, for receiving the possible reinforcement of the concrete tubbing, wherein the concrete tray has at least one base and base walls adapted, wherein at least one wall is releasable from the base and pivotable between a closed position and an opened position in relation to the base, comprising;
at least one drive system for pivoting the at least one wall between the open position and the closed position and for retaining said wall in the respective position; and,
at least one drive system actuator for pivoting the at least one wall between the open position and the closed position.

22. The formwork as claimed in claim 21, wherein in the closed position at least two walls at one of the two external end regions contact one another on the short sides of the walls to form a corner of the concrete tray.

23. The formwork as claimed in claim 22, further comprising a male engagement element in the external end region on one of the two walls, and a female engagement element in the external end region on the other wall, wherein in the closed position the two engagement elements engage with one another.

24. The formwork as claimed in claim 22, wherein the two walls in the external end regions are connected to one another by means of at least of at least one screw connection or one clamping connection, wherein the screw connection or clamping connection secures the position, and wherein the screw connection has a screw including a spring element which is disposed along at least part of the screw.

25. The formwork as claimed in claim 21, wherein the at least one wall for moving between the open position and the closed position is connected to at least two actuators of the drive system.

26. The formwork as claimed in claim 21, wherein the at least one wall element has two external end regions, and the formwork further comprises at least one actuator for moving and retaining the wall element per end region.

27. The formwork as claimed in claim 21, wherein the drive system at a workstation for driving the drive system is connectable to an external drive.

28. The formwork as claimed in claim 21, wherein the drive system is a hydraulic system comprising at least one hydraulic circuit connected to at least one hydraulic cylinder.

29. The formwork as claimed in claim 28, wherein the hydraulic circuit comprising a blocking element for maintaining the pressure in the hydraulic circuit, wherein said blocking element is a load-bearing valve.

30. The formwork as claimed in claim 28, wherein the hydraulic circuit comprises an element for equalizing at least one of a variation in terms of pressure or a variation of volume in the hydraulic circuit, and wherein the element is one of a dummy cylinder or a diaphragm accumulator.

31. The formwork as claimed in claim 28, wherein the hydraulic circuit comprises at least one connector element for releasably connecting the hydraulic circuit to a hydraulic apparatus as the external drive of the drive system at a workstation.

32. The formwork as claimed in claim 21, wherein the drive system actuator is a mechanical drive, including a spindle drive.

33. The formwork as claimed in claim 32, wherein the mechanical drive is at least one of self-locking, or includes a blocking element.

34. The formwork as claimed in claim 32, wherein the mechanical drive comprises a connecting element for releasably connecting to an external rotational drive, including a torque driver, as the external drive of the drive system at a workstation.

35. The formwork as claimed in claim 21, further comprising at least one cover element pivotable on the formwork, wherein the cover element is disposed on the upper side of the concrete tray and at least partially covering the upper side.

36. The formwork as claimed in claim 35, wherein the cover element is pivotable by at least one actuator between an open position and a closed position, the actuator retaining the cover element in the respective position.

37. The formwork as claimed in claim 35, wherein the cover element comprises an arrestor element which arrests the cover element in the closed position in relation to the formwork.

38. The formwork as claimed in claim 37, wherein the arrestor element is pivotable by at least one actuator between an open position and a closed position.

39. The formwork as claimed in claim 24, wherein the clamping connection comprises an arrestor element which is disposed on one of the wall elements and is pivotable by at least one actuator between an open position and a closed position.

40. The formwork as claimed in claim 36, wherein the respective actuator is connected to the drive system, wherein the drive system is a hydraulic system comprising at least one hydraulic circuit connected to at least one hydraulic cylinder.
